(19) United States
(12) Patent Application Publication
(10) Pub. No.: US 2010/0036721 A1
(43) Pub. Date: Feb. 11, 2010

(54) Method of Increasing Customer Loyalty With A Merchant

(75) Inventor: Rory Fatt, Delta (CA)

Correspondence Address: WESTMAN CHAMPLIN & KELLY, P.A., SUITE 1400, 900 SECOND AVENUE SOUTH, MINNEAPOLIS, MN, 55402, US

(73) Assignee: FIREPOWER MARKETING, INC., Blaine, WA (US)

(21) Appl. No.: 12/536,524

(22) Filed: Aug. 6, 2009

Related U.S. Application Data
(60) Provisional application No. 61/086,849, filed on Aug. 7, 2008.

(51) Int. Cl. G06Q 30/00

(52) U.S. Cl. 705/14.13; 705/14.36; 705/14.27

(57) ABSTRACT

A method of increasing customer loyalty and sales with a merchant includes providing a carrier to obtain demographic and contact information about a customer and enter the customer as a participant in a rewards program. This carrier also grants the loyalty program permission to market to them through any contact means they are given. The customer information is matched with a participant number. Promotional materials are sent to the participant wherein the promotional materials include a participant identifier and a promotional code wherein the promotional material is presented to a merchant to obtain points in the rewards program based upon the participant's activity with the merchant such that a card is not required to participate in the rewards program. The results of all marketing is analyzed to determine future customized marketing to target existing and potential customers with similar demographic profiles as merchants existing best customers.

### CROSS REFERENCE TO RELATED APPLICATION

The present application claims the benefit of U.S. Provisional Application Ser. No. 61/086,849 that was filed on Aug. 7, 2008, the contents of which are incorporated by reference in its entirety.

### FIELD OF THE INVENTION

The present invention generally relates to a loyalty rewards program that includes a turnkey direct marketing program between a program participant and a merchant. More specifically, the present invention relates to a rewards program based upon purchases and activities with a merchant that includes providing the program participant promotional material having a participant identifier that can be presented to the merchant in place of a participation card.

### BACKGROUND OF THE INVENTION

Loyalty rewards programs have been utilized to increase participant loyalty. One exemplary industry that successfully utilizes loyalty rewards programs is the airline industry where frequent use earns points for free flights.

Many merchants also utilize rewards programs. However, most of these rewards programs are based upon the program participant carrying a card in his or her wallet and/or purse. Also many merchants do not have a very sophisticated direct marketing follow up program that is customized to the individual participant and merchant. Based upon the number of rewards programs in existence, the number of rewards cards takes up a considerable amount of space in a participant's wallet or purse.

On average, Americans are members of over ten loyalty programs. Due to the bulkiness of the cards, participants are less likely to utilize the program because they do not want to carry the cards. Further, many merchants do not utilize the information provided in the rewards program to analyze their current participant demographics or use the information in the marketing or to target a prominent demographic of their participants.

### SUMMARY OF THE INVENTION

The present invention relates to a method of increasing customer loyalty with a merchant. The method includes providing a carrier to obtain information about a customer and enter the customer as a participant in a rewards program. The customer information is matched with a participant identifier. Promotional materials are sent to the participant wherein the promotional materials include the participant identifier and a promotional code wherein the promotional material is presented to a merchant to obtain points in the rewards program based upon the participant's activity with the merchant such that a card is not required to participate in the rewards program. The results of all marketing is analyzed to determine future customized marketing to target existing and potential customers with similar demographic profiles as merchants existing best customers.

### BRIEF DESCRIPTION OF THE DRAWINGS

FIG. 1 is a flow diagram of the rewards program of the present invention.

FIG. 2 is a flow diagram of how a participant is provided information to increase participant loyalty with a particular merchant.

FIG. 3 is a flow diagram of how reward points are accumulated and utilized by a participant.

FIG. 4 is a flow diagram of how a merchant can access participant information to increase business.

FIG. 5 is a top view of an exemplary promotional material that includes a participant identifier as well as indicia.

### DETAILED DESCRIPTION OF ILLUSTRATIVE EMBODIMENTS

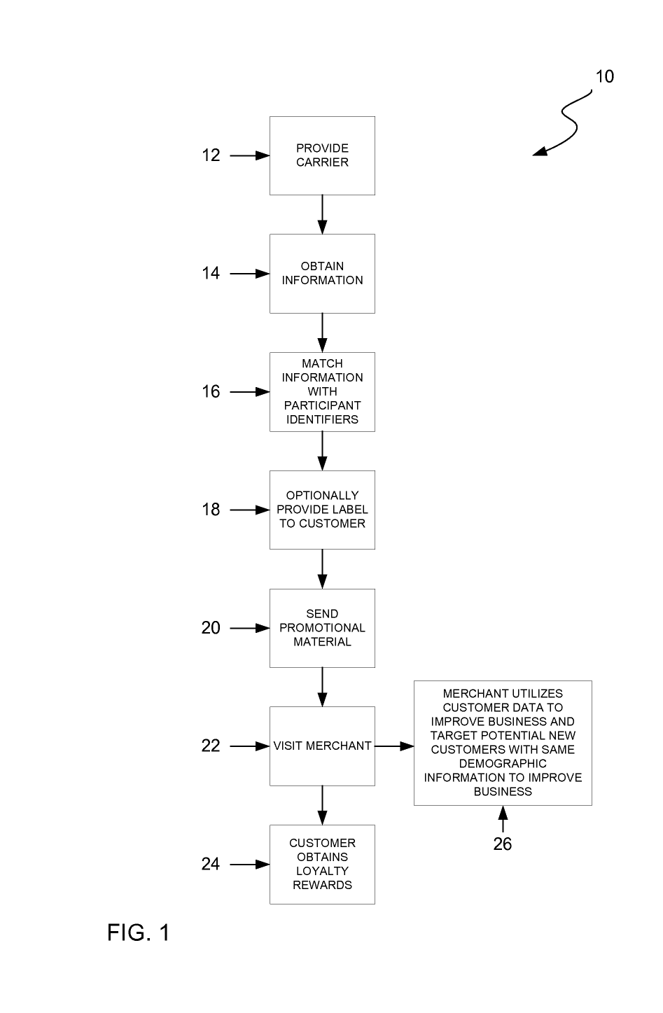

A method of increasing participant loyalty and also for generating new business through a loyalty rewards program is generally indicated at 10 in FIG. 1. The program utilizes a computer network to generate postcards and/or e-mails and other targeted communication to increase the frequency of participant visits to a merchant. Based upon the participant's spending at the merchant, the participant obtains reward points that can be utilized for awards, discounts, or rebates on future purchases which also improves the merchants revenues.

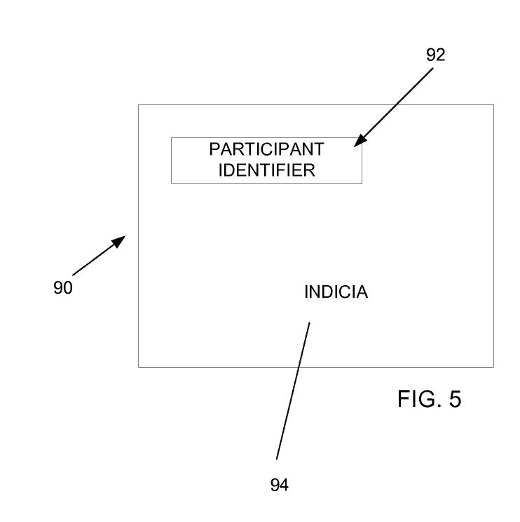

The program 10 utilizes participant information which is associated with promotional material 90 having a participant identifier 92 and optionally indicia 94 as best illustrated in FIG. 5. What is meant by a participant identifier is any marking that correlates the marking with a participant. A typical participant identifier is an optical machine-readable representation of data, such as a bar code. However, other identifiers are also contemplated including, but not limited to, a viewable number, an alpha-numeric sequence such as the person's name and at least one number, a numeric sequence, or a sequence of letters.

An exemplary participant identifier 92 on a paper based promotional material 90 is a bar code. The bar code typically includes information relating to the participant's program number. Optionally, the bar code can include information relating to a promotional code, such as, for example, a code for the participant's birthday. However, a promotional code is included in all promotional material, whether or not the promotional code is included in the bar code, such that the merchant can accurately track the effectiveness of the promotion as well as the demographics of the merchant's customers.

The bar code is scanned with a scanner at the merchant and the information is sent directly to the program provider where the scanned information is entered into the database. The merchant can purchase the scanners, or optionally, the program provider can provide the scanner to the merchant.

When electronic promotional material 90 is utilized, a bar code may not be effective, as the ability to read the bar code with a scanner may be adversely affected by a change in font, type style or size. Therefore, it may be necessary to utilize another participant identifier 92 when utilizing electronic promotional material 90.

The participant identifier 92 can be contained on a physical piece of material such as a promotional postcard or in electronic form such as an electronic file stored in memory on a device. An exemplary device on which the participant identifier 92 is stored is in memory on a cellular telephone, which is typically carried by the participant.

The promotional material 90 includes numerous forms of media including electronic promotional material, such as an e-mail message or a text message. The promotional material 90 having the participant identifier 92 allows the participant to utilize the promotional material 90 instead of a bulky participant identification card.

Referring to FIG. 5, the promotional material can also include indicia 94 such as the merchant's logo as well as the reward programs logo such that the participant is aware of both the merchant and the rewards program provider. What is meant by indicia is any distinctive marking that is utilized to distinguish the promotional material. Some indicia include, but is not limited to, the merchant's logo, the logo of the rewards program provider and a promotional code.

Instead of utilizing a hard plastic card, the promotional material 90 optionally include a label that can be attached to any card or any item that is typically carried in a participant's wallet and/or purse. The utilization of a label minimizes the thickness of the loyalty card which in turn will lead to the participant to carry the selected merchant's loyalty rewards information with them. Merchants utilizing credit card type loyalty reward cards have found that due to the bulk and size of the cards, and the number of the cards that their reward participants carry, there is less frequent use of the reward programs.

The label is flexible and thin in nature and typically includes a backing sheet that is removed to expose a tackified back surface. One such tackified back surface would be a pressure sensitive adhesive. Additionally, a static electricity type of adhesion can be used. By utilizing a static electricity adhesion, the label can be easily removed and placed on another surface. A non-permanent pressure sensitive adhesive also allows the label to be moved from one surface to another. However, a permanent pressure sensitive adhesive is also contemplated.

The label is typically coated with a varnish that prevents the indicia from rubbing off during normal usage. Also, the label is very thin, typically made from a durable material such as vinyl, and has rounded corners so it does not catch an edge and come off.

Referring back to FIG. 1, The method 10 includes obtaining the participant's information at step 12 by providing a carrier that includes a plastic card. The carrier is typically on a 8½×11 tri-fold piece of paper which contains the merchant's logo as well as the reward program's logo. When the participant views the carrier, the participant becomes aware of both the merchant and the reward program manager. The carrier also includes the terms of the reward program and also explains the benefits of joining the reward program. Once the participant has obtained and filled out the information on the carrier, the merchant collects the carrier with the information and enters the information on the secure web site. Alternatively, the merchant can forward the information to the reward program provider for entry which is entered into a participant database.

The rewards program participant then receives the loyalty card, which was previously affixed to the carrier. However, providing the card to the merchant is not necessary to participate in the rewards program.

The carrier typically includes information that the participant provides such as the participant's birthday, anniversary, age and street address. Additional information may include the participant's sex, phone, cellular and fax numbers and e-mail address. This participant's information is entered into a database at step 14. Typically, the carrier is forwarded to the loyalty program provider to be entered by a data entry employee employed by the loyalty program provider through the secure website. An alternative method of data entry would be to have the information is entered by a data entry employee employed by the merchant on the secure web site.

Once the participant's information is entered, the participant is given a participant identifier at step 16 at which time the participant is entered into the rewards program. It is important to ensure that the participant's identifier is associated with the participant's information. If the participant information does not correspond to the participant identifier then it would not be possible to track the participant's information regarding the effectiveness of the promotional materials as well as to obtain accurate demographic information regarding the merchant's business.

Once the participant identifier has been verified to correspond to the participant information, the rewards program manager can optionally issue the label to the participant which includes the participant identifier 92 containing information relating to at least the participant number at step 18.

Once the participant is entered into the rewards program, the rewards program begins sending the participant promotional information at step 20. For instance, the rewards program will send the new participant a welcoming postcard such that the participant feels a sense of appreciation for entering the program. Also, on selected days throughout the year, both based upon personal information as well as seasonal events, postcards will be sent to the participant with promotional offers where every promotional material includes a unique promotional code that allows the merchant to evaluate the participation in the promotion. Examples of personal dates for which postcards will be sent to provide promotional materials as well as special offers on goods include the participant's birthday, six months prior to or after the participant's birthday, the participant's anniversary date as well as six months after the participant's anniversary or birthday. Others example are seasonal or speciality promotions throughout the year.

Typically all promotional material includes the participant identifier, typically a bar code, containing information relating to the participant's number and the promotion. Once the bar code is scanned, the information including, but not limited to the participant number, is automatically entered into the database. The dollar amount purchased is either manually keyed into the terminal or transmitted electronically through a data file as a separate item, combined with the members tracking information.

Similarly, promotional postcards and e-mails will be sent regarding specific nights or periods of time which are designated as “Date Night” or a seasonal promotion. Typically, these promotions are at times of the week or period of the year when the merchant wants to build traffic or sales. By providing these promotional events, merchants are able to increase their revenues over the more typically slow times when they have extra capacity or excess merchandise in inventory.

The promotional materials 90, such as postcards, are digitally produced such that the promotional material 90 can be customized for a particular marketing campaign, a specific business or a particular participant. Since the postcards are digitally produced and then printed, the merchant is provided flexibility regarding the postcard graphics such that a particular merchant is prominently shown, especially when the postcard is being utilized in a multi-merchant situation where two or more merchants are working together on the marketing or promotional campaign. Each piece of promotional material 90 is customized and unique to that rewards program participant and merchant.

Additionally, the personal information obtained typically includes the participant's e-mail address. The participant in the rewards program obtains points for providing a valid e-mail address over a period of time. Further, the e-mail address also provides the rewards program another means of communicating with the rewards program participant. For instance, if the rewards program participant does not visit the merchant based upon the personal mailings, an e-mail reminder can be sent to the participant that encourages the participant to frequent the merchant's business.

Also, the e-mail address is utilized to obtain feedback for the merchant from their best clients, which has been found to be more accurate and candid than on-site surveys as well as mystery shopping participants. For instance, the e-mail may include a survey, triggered at prearranged times or after a certain spending activity determined by the merchant, which would provide points for the rewards program based upon participation. The surveys typically ask yes/no questions or ask for a grading on a scale of 1-5 which take little time to complete. Also, the survey includes open-ended questions which request information regarding the participant's purchase experience at the merchant. It has been found that these surveys, which the rewards program participant fills out away from the site, are found to be more accurate and beneficial for the merchant because the participant has had the time to reflect upon the experience as well as fill out the survey in the comfort of his or her own home at a convenient time without the worry that the merchant's employee will see the feedback directly, providing the feeling of anonymity when filling out the survey. The participant is also provide rewards points for filling out the survey.

When a participant arrives at a merchant, the participant is able to produce the promotional material 90, whether a postcard, label or electronic communication having the participant identifier 92 which is scanned to gain frequency or loyalty rewards at step 22. Once the participant identifier 92 is scanned, the participant receives rewards for his or her purchases.

An additional benefit of utilizing the participant rewards program is that the merchant is able to utilize information regarding the participant purchases and demographic information to tailor the merchant marketing to a specific demographic, as well as to pursue a demographic which the merchant may not be aware at step 26. Once the targeted demographic is identified, the program provider compares the data on the targeted demographic with the rewards program participant information and removes any duplicative information or records from the targeted demographic list to ensure existing members aren't targeted. Removing redundancy from the targeted demographic also reduces the cost of the promotional activity to the merchant.

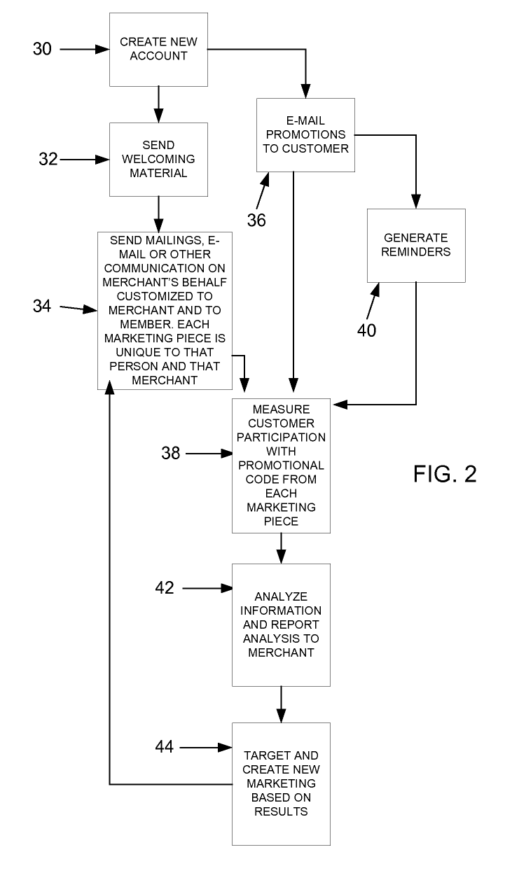

Referring to FIG. 2, once a new account has been created at step 30, a promotional material 90, whether a postcard, an e-mail or other marketing communication, is sent to welcome the participant at step 32 as previously mentioned. Also, promotional materials 90 are sent on seasonal and personal dates at step 34. Additionally, and along with the direct mailings, e-mail is used to promote the merchant to the participant at step 36.

The rewards program provider's services include a review process to determine whether the participant is utilizing the rewards program. The review process will trigger an automatic e-mail or Lost Customer Mailing Sequence to the participant at step 40 to encourage participation. It has been found that utilizing the above described method, the participant increases the frequency and number of visits to the merchant.

The rewards program provider measures the customer participation with the promotional code at step 38. Measuring the customer participation along with the promotional code allows the rewards program provider to analyze the effectiveness of the promotion and generate a report regarding the analysis that is provided to the merchant at step 42. The report analysis allows the merchant to target a demographic and create new marketing based upon the results of the report at step 44. Promotional materials are then sent to the program participants as well as the targeted demographic at steps 34 and 36. The effectiveness of the promotion is measured and analyzed at steps 38 and 42 such that another round of promotional materials can be sent to a targeted demographic at steps 42 and 34. The process described in steps 34-42 is repeated to continually reach a new targeted demographic while maintaining the loyalty of the program participants and thereby increase the merchant's business.

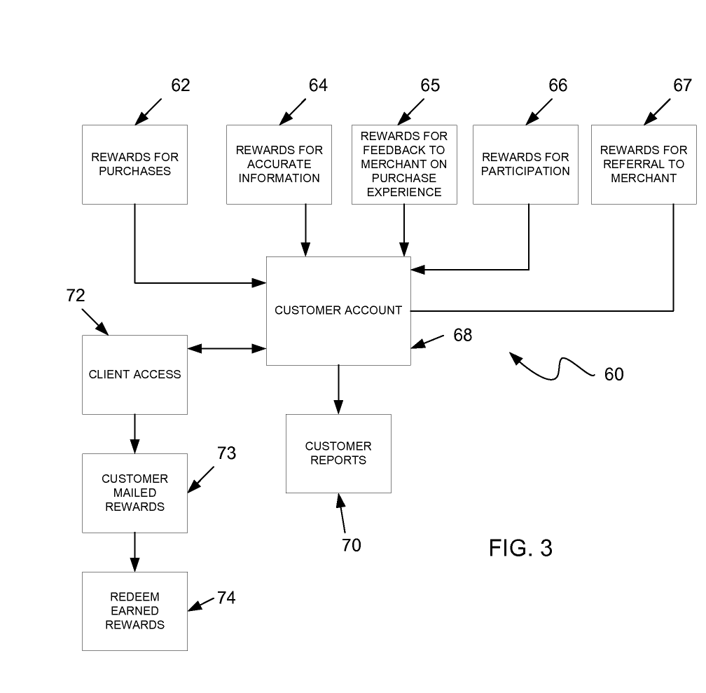

Referring to FIG. 3, a flow chart is generally illustrated at 60 which depicts participant utilization of the rewards program. The participant obtains points for purchases at the merchant or other merchant at step 62. The participant also receives points for providing accurate information to the merchant such as an accurate e-mail account over time at step 64. The participant also receives reward points for participating in the program such as providing feedback through survey information at step 65. Additionally, the participant can receive participation points for referring a friend to the rewards program at step 67. The participant can also receive participation points for participating in other activities within the program at step 66. All of the reward points are accumulated and monitored in a participant account at step 68 which is typically available over the internet at a specific web site or URL with a secure password.

The rewards program will generate a quarterly report for the participant at step 70. The report typically includes a summary of the participant's reward points, activities that could earn potential reward points and activities that can accrue incremental additional points. Additionally, the participant can access the participant account at step 72 via the internet to monitor the participant's account as well as to update the participant's personal information.

Once the participant accumulates enough points, a reward certificate is mailed to the participant at step 73. This updated information then again is utilized to redeem loyalty points at the merchant at step 74.

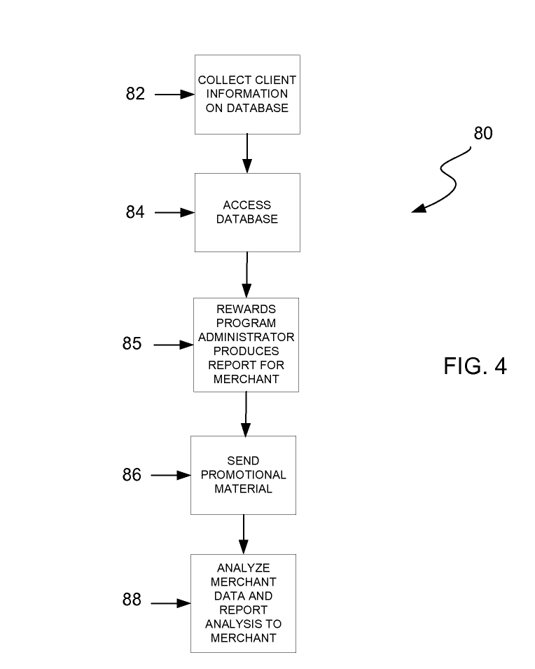

Referring to FIG. 4, a flow diagram is provided which provides a method as to how the merchant can utilize the rewards program to improve the merchant's business is generally depicted at 80. The rewards program allows the merchant to gather information on its program participants in a database at step 82. The database is then accessed on a secure web site at step 84. Once the merchant has accessed the web site, the merchant can then access analysis of the merchant's data that is provided by the rewards program provider. A printout of the analysis can also be sent to merchant.

The analysis includes, but is not limited to, the program participant's demographic data, participant loyalty information and information it receives from its surveys to improve its relationship with current participants at step 86 as well as to utilize the demographics of its current participants to target new participants based upon any of a number of variables. Some of these variables include age, sex, location or address, distance of members residence from business, earnings and family information such as whether the participant is single, married or has children.

Based upon the information obtained, the merchant is then able to send promotional advertising and marketing information to its current participants as well as a targeted demographic at step 86. Additional analysis is then provided to the merchant at step 88 based upon the effectiveness of the promotional material that was sent in step 86.

By utilizing this method, it has been found that merchants have been able to dramatically increase the revenue of its businesses. The merchant can also optionally enter into a multi-merchant loyalty program with other merchants such that a participant identifier can be utilized by the participant and where loyalty points can optionally be accumulated and redeemed through multiple merchants.

Although the present invention has been described with reference to preferred embodiments, workers skilled in the art will recognize that changes may be made in form and detail without departing from the spirit and scope of the invention.

1. A method of increasing customer loyalty with a merchant, the method comprising:
providing a carrier to obtain information about a customer and enter the customer as a participant in a rewards program;
matching the customer information with a participant number; and
sending promotional material to the participant wherein the promotional material includes a participant identifier and a promotional code wherein the promotional material is presented to a merchant to obtain points in the rewards program based upon the participant's activity with the merchant.

2. The method of claim 1 and wherein the information obtained from the participant comprises at least two of the participant's birthday, anniversary, age and street address.

3. The method of claim 2 and wherein the information obtained from the participant includes at least one of the participant's sex, telephone number, cellular telephone number, facsimile number and e-mail address.

4. The method of claim 1 and wherein the participant obtains rewards points for providing an accurate e-mail address to the merchant.

5. The method of claim 1 and wherein sending promotional materials to the participant comprises sending promotional materials to an e-mail account.

6. The method of claim 1 and wherein sending promotional materials to the participant comprises sending a postcard with customized graphics to the participant's street address.

7. The method of claim 6 and further comprising sending an e-mail to the participant to remind the participant of the promotion when the postcard is not utilized by the participant at the merchant.

8. The method of claim 1 and further comprising providing the participant access to the participant's account through a specific web site or URL protected with a secure password such that the participant can monitor the account and update the participant's information.

9. The method of claim 1 and further comprising providing the merchant an analysis of the participant's database such that the merchant can utilize the analysis to target a specific demographic to increase the activity with the merchant.

10. The method of claim 9 and wherein providing the merchant an analysis of the participant's database includes analyzing the merchants member database and participant's demographic information to focus marketing campaigns to attract new customers who are in the same demographic but not participants in the rewards program.

11. The method of claim 9 and wherein providing the merchant an analysis of the participant's database further includes providing the merchant an analysis of the participants information and activity of with the merchant such that the merchant is capable of determining the effectiveness of the merchant's promotions.

12. The method of claim 1 and wherein the customer information is entered into a database by the merchant.

13. The method of claim 1 and wherein the customer information is entered into a database utilizing a scanner.

14. The method of claim 1 and wherein the promotional material includes a label.

15. The method of claim 1 and wherein the promotional material comprises a direct mailing or an electronic communication.

16. The method of claim 1 and wherein the participant identifier comprises a bar code.

17. The method of claim 16 and the bar code includes the participant identifier and a promotional code.

18. A method of increasing customer loyalty with a merchant, the method comprising:
providing a carrier to obtain information about a customer and enter the customer as a participant in a rewards program;
matching the customer information with a participant number;
providing a flexible label to the participant that includes a tackified surface and a participant identifier on a surface opposing the tackified surface wherein the bar code includes information about the participant number; and
utilizing the participant identifier to update a database that records obtained points in the rewards program based upon the participant's activity with the merchant wherein participation in the rewards program increases the participant's loyalty with the merchant.

19. The method of claim 18 and further comprising:
sending promotional materials to the participant wherein the promotional materials include a participant identifier containing information about the participant number and the promotion code to track results; and
providing the promotional material to the merchant wherein the second bar code is scanned by the merchant such that the participant obtains points in the rewards program based upon the participant's activity with the merchant and wherein the database is updated to record information about the participant and the promotion such that the merchant can analyze the data to determine the effectiveness of the promotional materials.

20. The method of claim 18 and wherein the participant identifier comprises a bar code containing the participant number.
